(19) United States
(12) Patent Application Publication
(10) Pub. No.: US 2012/0314405 A1
(43) Pub. Date: Dec. 13, 2012

(54) Apparatus for Spinning a Fan Towel

(76) Inventor: Michael B. Culpepper, Las Vegas, NV (US)

(21) Appl. No.: 13/154,438

(22) Filed: Jun. 7, 2011

(51) Int. Cl. F21L 4/02; B25G 1/00; F21V 21/30; F21V 21/00; F21S 4/00

(52) U.S. Cl. 362/184; 362/382; 362/249.01; 362/427; 16/110.1

(57) ABSTRACT

An apparatus comprises a rod comprising a first length wise cavity and a second length wise cavity comprising a length wise slot extending to a distal end of the rod. The second length wise cavity is configured for joining to an article promoting fan support. A head member is rotatably joined to the rod for supporting the rod. A handle is rotatably joined to the head member for enabling the head member to rotate about the handle where the rod rotates in a plane generally perpendicular to the handle and for enabling the rod to be rotated to a position generally parallel to the handle. An end cap is joined to the distal end of the rod and closing the first length wise cavity and the second length wise cavity. A light source is configured to fit within the first cavity.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to sporting goods. More particularly, the invention relates to a device that aids in spinning a fan towel.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Many people regularly attend sporting events (e.g., without limitation, professional football, college basketball, little league baseball, etc.), and these sports fans do not go just to watch. People attending these events typically root and cheer to be an active part of the game. Fans often yell, scream, and wave objects such as, but not limited to, banners, signs, pointing foam fingers, fan towels, etc. Fan towels typically bear the name, logo and/or color of the fan-favored team and are usually spun in the air to cheer on the players on the field. Furthermore, fans watching sporting event on televisions may like to decorate with and use these types of fan items inside their homes.

Sports souvenirs and related products have been an abiding interest of wide segments of manufacturers, suppliers, and retailers. Included among these, without limitation, are sporting goods stores and gifts and novelties stores as well as private individuals. It is believed that new and creative products may have the potential to provide exceptional value and inventive customer utility to attract and hold a larger share of this market.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A, 1B and 1C illustrate an exemplary towel spinning device, in accordance with an embodiment of the present invention. FIG. 1A is a diagrammatic side view of the device in an open position. FIG. 1B is a diagrammatic side view of the device in a folded position, and FIG. 1C is a top perspective view of the device;

FIGS. 2A and 2B illustrate a towel receiving end of a housing rod of an exemplary towel spinning device in accordance with an embodiment of the present invention. FIG. 2A is a side perspective view with an end cap in an open position, and FIG. 2B is a side perspective view of the end cap in a closed position;

FIGS. 3A and 3B illustrate an exemplary towel for use with a towel spinning device, in accordance with an embodiment of the present invention. FIG. 3A is a diagrammatic top view, and FIG. 3A is a diagrammatic side view; and

FIGS. 4A and 4B illustrate an exemplary towel spinning device in use, in accordance with an embodiment of the present invention. FIG. 4A is a side perspective view of the device with an attached towel, and FIG. 4B is a diagrammatic top view of the device and the towel in motion.

Unless otherwise indicated illustrations in the figures are not necessarily drawn to scale.

### SUMMARY OF THE INVENTION

To achieve the forgoing and other objects and in accordance with the purpose of the invention, a variety of devices for spinning a fan towel are described.

In one embodiment an apparatus comprises a rod being configured for joining to an article promoting fan support. A head member is joined to the rod for supporting the rod. A handle is rotatably joined to the head member for enabling the head member to rotate about the handle where the rod rotates in a plane generally perpendicular to the handle. In another embodiment the head member is further rotatably joined to the rod enabling the rod to be rotated to a position generally parallel to the handle. In yet another embodiment the rod further comprises a length wise slot extending to a distal end and configured for accepting an article promoting fan support. In still another embodiment an end cap for joining to the distal end of the rod and closing a distal end of the length wise slot. Another embodiment further comprises a hinge for joining the end cap to the distal end of the rod. In yet another embodiment the rod further comprises a light source. In still another embodiment the light source comprises a row of lights. Another embodiment further comprises a compartment for housing an energy source for powering the lights. Yet another embodiment further comprises a switch for turning the lights on and off. In still another embodiment the rod further comprises a first length wise cavity for containing the row of lights and a second length wise cavity for containing a boarder of an article promoting fan support. Another embodiment further comprises a fan towel being configured for being accepted into the length wise slot and the length wise cavity. In yet another embodiment the fan towel further comprises an extended boarder being configured to fit within the second cavity. In still another embodiment the fan towel further comprises curved hem on a lower edge.

In another embodiment an apparatus comprises means for joining to an article promoting fan support, means for rotatably supporting the joining means, means rotatably joined to the supporting means for enabling the supporting means to rotate where the joining means rotates in a plane generally perpendicular to the enabling means, and for further enabling the joining means to be rotated to a position generally parallel to the enabling means, means for joining to a distal end of the joining means to close the distal end, and means for illuminating the joining means.

In another embodiment an apparatus comprises a rod comprising a first length wise cavity and a second length wise cavity comprising a length wise slot extending to a distal end of the rod. The second length wise cavity is configured for joining to an article promoting fan support. A head member is rotatably joined to the rod for supporting the rod. A handle is rotatably joined to the head member for enabling the head member to rotate about the handle where the rod rotates in a plane generally perpendicular to the handle and for enabling the rod to be rotated to a position generally parallel to the handle. An end cap is joined to the distal end of the rod and closing the first length wise cavity and the second length wise cavity. A light source is configured to fit within the first cavity. Another embodiment further comprises a hinge for joining the end cap to the distal end of the rod. In yet another embodiment the light source comprises a row of lights. Still another embodiment further comprises a compartment for housing an energy source for powering the lights. Another embodiment further comprises a switch for turning the lights on and off. Yet another embodiment further comprises a fan towel comprising an extended boarder being configured to fit within the second cavity and a curved hem on a lower edge.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

A preferred embodiment of the present invention and at least one variation thereof provide a towel spinning device comprising a sports fan towel attached upon a lighted rod that can rotate in planar circular patterns upon a hosting handle.

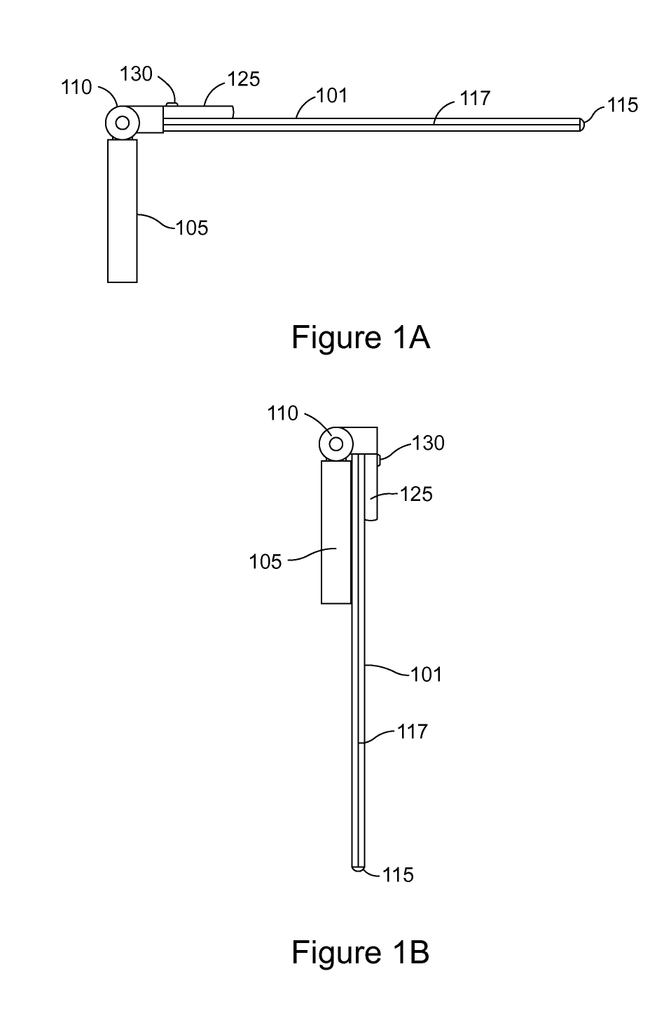

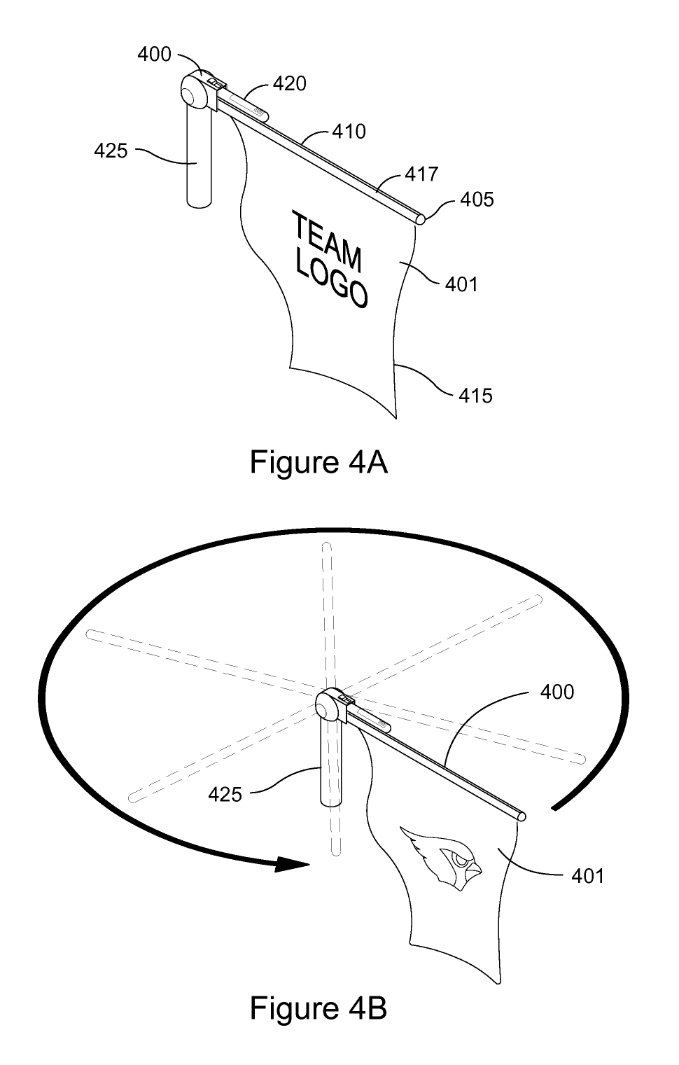

FIGS. 1A, 1B and 1C illustrate an exemplary towel spinning device, in accordance with an embodiment of the present invention. FIG. 1A is a diagrammatic side view of the device in an open position. FIG. 1B is a diagrammatic side view of the device in a folded position, and FIG. 1C is a top perspective view of the device. In the present embodiment, the device comprises a housing rod 101 attached to a handle 105 by a pivoting and rotating head 110. Head 110 can rotate in a three-hundred-and-sixty-degree (360°) horizontal pattern upon handle 105 to enable housing rod 101 to rotate in a planar circular pattern. Referring to FIG. 1B, head 110 also enables handle 105 to pivot with respect to housing rod 101 to enable the device to be easily folded for secure transport and storage. An end cap 115 upon the free end of housing rod 101 can secure a cloth such as, but not limited to, a fan towel upon housing rod 101, as shown by way of example in FIGS. 4A and 4B.

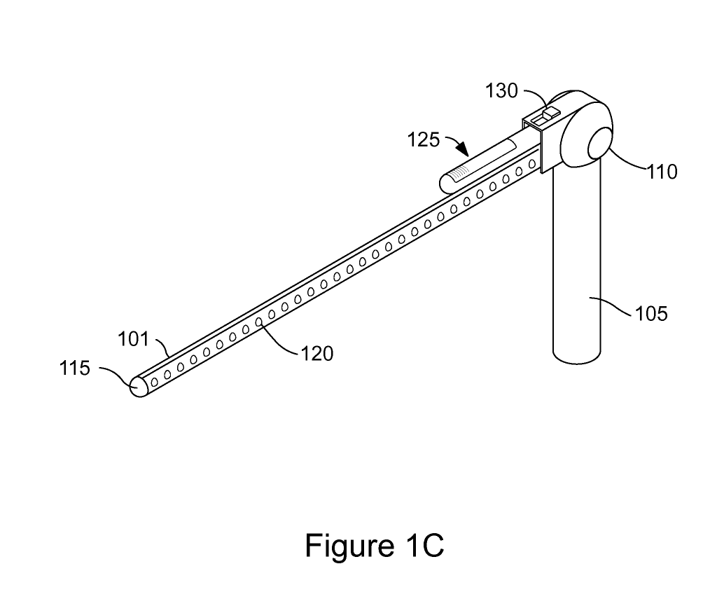

In the present embodiment, housing rod 101 is typically made of low-density polyethylene (LDPE) and measures fourteen inches in length by one-half of one inch in diameter (14″×½″). In some alternate embodiments, the housing rod can be made of various different materials of adequate durability such as, but not limited to, polymethyl methacrylate, various other plastics, various lightweight metals, etc. Furthermore, some alternate embodiments may comprise housing rods in various different lengths and diameters. In the present embodiment, referring to FIGS. 1A and 1B, one plane of housing rod 101 comprises an open slit 117 throughout its length through which a cloth may extend, as shown by way of example in FIG. 4A. Rounded end cap 115 attaches to housing rod 101 by a hinge, as shown by way of example in FIGS. 2A and 2B. The opposite end of housing rod 101 attaches to head 110, from which housing rod 101 can vertically pivot to a maximum ninety-degree (90°) arc from supporting handle 105. Head 110 also attaches to, and can freely rotate three-hundred-and-sixty degrees (360°) upon, supporting handle 105. The range of motion of the head in some alternate embodiments may vary. For example, without limitation, the housing rod may pivot at the head to an angle greater than or smaller than ninety degrees (90°). In some non-foldable alternate embodiments, the head may not enable the housing rod to pivot with respect to the handle. In the present embodiment, handle 105 is typically made of polyvinyl chloride (PVC) material and measures six inches in length by three-quarters of one-inch in diameter (6″×¾″). However, it is contemplated that in some alternate embodiments the handle can be made of various different materials of adequate durability such as, but not limited to, polystyrene (PS), polyvinyl chloride (PVC), various other plastics, rubber, various lightweight metals, etc. In addition, the handles in some alternate embodiments can be made in various different lengths and diameters.

In the present embodiment, referring to FIG. 1C, the device comprises lighting within housing rod 101 in the form of a horizontal row of light-emitting diodes (LED) 120 of five millimeter (5 mm) size on one side of housing rod 101. Those skilled in the art, in light of the present teachings, will readily recognize that a multiplicity of suitable lighting means may be used in some alternate embodiments such as, but not limited to, LEDs of various different sizes, neon lights, chemical light sticks, incandescent bulbs, etc. Some alternate embodiments may be made in variations that do not include lighting means. In the present embodiment, LEDs 120 are powered by, and connected by wire to, a single battery of AAA size which fits within a battery hosting compartment 125 upon the top-interior endpoint of housing rod 101. In some alternate embodiments this battery hosting compartment can be featured in various different locations upon the device such as, but not limited to, different points along the housing rod, within the housing rod, on or within the handle, etc. Also, battery hosting compartments in some alternate embodiments can host various different types and sizes of batteries in various different quantities. In the present embodiment, the top section of battery hosting compartment 125 can be removed for the insertion of the battery. In alternate embodiments the battery hosting compartment may have various different opening means such as, but not limited to, a screw-on end cap. In the present embodiment, a power switch 130 is featured upon the top plane of battery hosting compartment 125; however, this switch may be located in a multiplicity of suitable points on the device in alternate embodiments. Furthermore, other alternate embodiments may be implemented without a power switch. In these embodiments, the lighting means are extinguished by removing the batteries from the battery hosting compartment. Yet other alternate embodiments that comprise lighting means that do not require electricity or that do not include lighting means may be implemented without a battery hosting compartment or a power switch. In the present embodiment, LEDs 120 can garner more attention to and can generally ensure the visibility of a fan towel attached to housing rod 101 and its messages and/or logos. This lighting may also add decoration to a fan towel attached to housing rod 101. The portion of housing rod 101 covering LEDs 120 is made of a clear or translucent material to generally ensure that LEDs 120 are visible. Furthermore, the remaining structure of housing rod 101 may also be made of a clear or translucent material; however, this portion of the rod in some alternate embodiments may be made of an opaque material. Some alternate embodiments may comprise LEDs of various different colors, sizes and shapes, and in various different numbers of units and configurations. Some alternate embodiments may comprise interchangeable LEDs. In these interchangeable embodiments the LEDs may be hosted upon a track so that the LEDs may be easily changed.

FIGS. 2A and 2B illustrate a towel receiving end of a housing rod 201 of an exemplary towel spinning device in accordance with an embodiment of the present invention. FIG. 2A is a side perspective view with an end cap 205 in an open position, and FIG. 2B is a side perspective view of end cap 205 in a closed position. In the present embodiment, rounded end cap 205 attaches to housing rod 201 and moves by a hinge 210. A finger tab 215 projects from the opposite edge of rounded end cap 205 from hinge 210 to provide a user with a grip to open end cap 205. Some alternate embodiments may be implemented without a finger tab.

Referring to FIG. 2A, in the present embodiment, a lighting cavity 220 of housing rod 201 houses LEDs 225. In some alternate embodiments, this lighting cavity may be permanently sealed. In the present embodiment, a towel cavity 230 of housing rod 201 provides an area into which a portion of a fan towel may be inserted. When this portion of the fan towel is inserted into towel cavity 230, the remainder of the towel extends out through a slit 235. End cap 205 snaps securely into place when closed to generally prevent the towel from coming out of housing rod 201 when in use. Those skilled in the art, in light of the present teachings, will readily recognize that end caps in some alternate embodiments may be held closed by various different means. For example, without limitation, end caps may screw onto or into threads on the end of the rod in some alternate embodiments. In other alternate embodiments the end cap may snap on and off of the rod without a hinge. Yet other alternate embodiments may be implemented without a removable cap on which the towels are permanently attached.

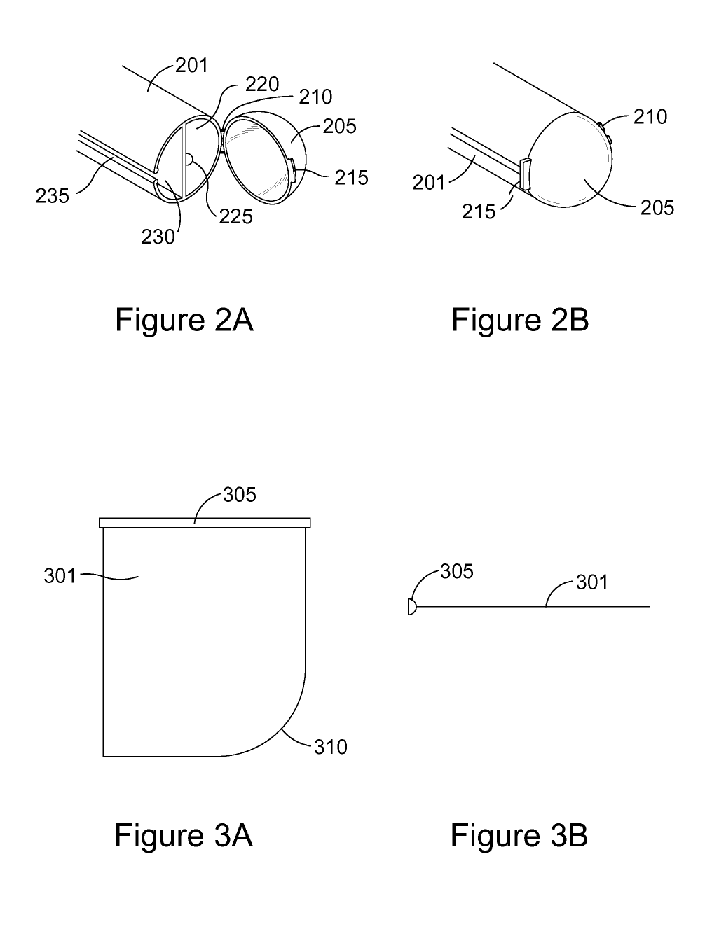

FIGS. 3A and 3B illustrate an exemplary towel 301 for use with a towel spinning device, in accordance with an embodiment of the present invention. FIG. 3A is a diagrammatic top view, and FIG. 3A is a diagrammatic side view. In the present embodiment, towel 301 measures approximately fourteen inches in width by eighteen inches in length (14″×18″) and is typically produced of a terry cloth material bearing a specific logo and/or design. It is contemplated that in some alternate embodiments, the towel can be of various different sizes and shapes that are compatible with the sizes of the towel spinning devices that host the towels. Additionally, in some alternate embodiments, the towels can be made of various different materials such as, but not limited to, cotton/polyester blends, polyester, nylon, etc. In some alternate embodiments items may be spun on the device that are made of materials other than cloth such as, but not limited to, paper, cardboard, plastic, etc. In the present embodiment, towel 301 can be made in various different colors and may bear a variety of wordage, images and/or logos, which may or may not be of registered trademark and/or copyright status. In some alternate embodiments multiple towels of various different colors and designs may be included with a single towel spinning device. In some embodiments, additional towels may be sold separately.

In the present embodiment, the top plane of towel 301 comprises an extended border 305 of polyvinyl chloride (PVC) that is shaped and sized to fit into an accommodating towel cavity of a housing rod of a towel spinning device. Extended border 305 generally ensures the secure attachment of towel 301 to the towel spinning device. In the present embodiment, extended boarder 305 has a semi-circular cross section to match the shape of the towel cavity of the housing rod into which extended border is to be inserted. In some alternate embodiments, the extended borders may have various different shapes to match housing rods of various different shapes and sizes. Additionally, some alternate embodiments may be made of various different materials such as, but not limited to, various different plastics, the folded material of the towel, foam, rubber, etc. In the present embodiment, a curved hem 310 is located at the outer, lower edge of towel 301. The curve of hem 310 helps to generally maintain towel 301 in a flat and planar position while in motion. By maintaining towel 301 in a flat position while being spun, the device generally ensures greater visibility of towel 301 and any designs upon towel 301. In some alternate embodiments the towels may not have curved hems and may be made in a multiplicity of suitable shapes including, but not limited to, rectangles, triangles, circular shapes, shapes to match particular logos, etc.

FIGS. 4A and 4B illustrate an exemplary towel spinning device 400 in use, in accordance with an embodiment of the present invention. FIG. 4A is a side perspective view of device 400 with an attached towel 401, and FIG. 4B is a diagrammatic top view of device 400 and towel 401 in motion. In typical use of the present embodiment, towel 401 is removable from device 400 for storage and transport. Referring to FIG. 4A, to attach towel 401 to device 400, a user opens a rounded end cap 405 of a housing rod 410. The user may then insert the extended border of towel 401 within housing rod 410, generally ensuring that a curved hem 415 is located in the lower-exterior position and towel 401 is aligned with a slit 417 in housing rod 410. The user may then close end cap 405. The lighting of device 400 can be turned on by a power switch 420 if the user so desires. Referring to FIG. 4B, the user can then use device 400 to display fan enthusiasm by holding a handle 425 and rotating rod 410 and attached towel 401 in a circular motion around handle 425. Towel 401 can be removed and replaced with other towels at any time. One can expect that towel spinning device 400 may be brought to a wide variety of events such as, but not limited to, professional football games, baseball games, basketball games, soccer games, collegiate athletic games, school and little league games, concerts, shows, automotive races, monster truck rallies, etc. Towel spinning device 400 may also be used at home.

Those skilled in the art, in light of the present teachings, will readily recognize that alternate embodiments may be implemented with a multiplicity of additional features such as, but not limited to, textured handles, ergonomic grips on the handles, air horns, ratcheting noisemakers, whistles, speakers for playing team music, logos on the device itself, clips, carrying straps, etc. Some alternate embodiments of the present invention may comprise telescoping housing rods to enable the devices to collapse to a smaller size for storage and transport. Other alternate embodiments may comprise a small motor in the handle or head to automatically rotate the housing rod and attached towel.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of spinning a fan item according to the present invention will be apparent to those skilled in the art. The invention has been described above by way of illustration, and the specific embodiments disclosed are not intended to limit the invention to the particular forms disclosed. For example, the particular implementation of the spinning device may vary depending upon the particular type of item being spun. The spinning devices described in the foregoing were directed to towel spinning implementations; however, similar techniques are to provide devices that spin items other than towels such as, but not limited to banners, flags, streamers, signs, hats, scarves, inflatable objects, etc. Non-towel spinning implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. An apparatus comprising:
a rod being configured for joining to an article promoting fan support;
a head member being joined to said rod for supporting said rod; and
a handle being rotatably joined to said head member for enabling the head member to rotate about said handle where said rod rotates in a plane generally perpendicular to said handle.

2. The apparatus as recited in claim 1, in which said head member is further rotatably joined to said rod enabling said rod to be rotated to a position generally parallel to said handle.

3. The apparatus as recited in claim 1, in which said rod further comprises a length wise slot extending to a distal end and configured for accepting an article promoting fan support.

4. The apparatus as recited in claim 3, further comprising an end cap for joining to said distal end of said rod and closing a distal end of said length wise slot.

5. The apparatus as recited in claim 4, further comprising a hinge for joining said end cap to said distal end of said rod.

6. The apparatus as recited in claim 1, in which said rod further comprises a light source.

7. The apparatus as recited in claim 6, in which said light source comprises a row of lights.

8. The apparatus as recited in claim 7, further comprising a compartment for housing an energy source for powering said lights.

9. The apparatus as recited in claim 8, further comprising a switch for turning said lights on and off.

10. The apparatus as recited in claim 7, in which said rod further comprises a first length wise cavity for containing said row of lights and a second length wise cavity for containing a boarder of an article promoting fan support.

11. The apparatus as recited in claim 10, further comprising a fan towel being configured for being accepted into said length wise slot and said length wise cavity.

12. The apparatus as recited in claim 11, in which said fan towel further comprises an extended boarder being configured to fit within said second cavity.

13. The apparatus as recited in claim 11, in which said fan towel further comprises curved hem on a lower edge.

14. An apparatus comprising:
means for joining to an article promoting fan support;
means for rotatably supporting said joining means;
means rotatably joined to said supporting means for enabling said supporting means to rotate where said joining means rotates in a plane generally perpendicular to said enabling means, and for further enabling said joining means to be rotated to a position generally parallel to said enabling means;
means for joining to a distal end of said joining means to close said distal end; and
means for illuminating said joining means.

15. An apparatus comprising:
a rod comprising a first length wise cavity and a second length wise cavity comprising a length wise slot extending to a distal end of said rod, said second length wise cavity being configured for joining to an article promoting fan support;
a head member being rotatably joined to said rod for supporting said rod;
a handle being rotatably joined to said head member for enabling said head member to rotate about said handle where said rod rotates in a plane generally perpendicular to said handle and for enabling said rod to be rotated to a position generally parallel to said handle;
an end cap for joining to said distal end of said rod and closing said first length wise cavity and said second length wise cavity; and
a light source being configured to fit within said first cavity.

16. The apparatus as recited in claim 15, further comprising a hinge for joining said end cap to said distal end of said rod.

17. The apparatus as recited in claim 15, in which said light source comprises a row of lights.

18. The apparatus as recited in claim 15, further comprising a compartment for housing an energy source for powering said lights.

19. The apparatus as recited in claim 18, further comprising a switch for turning said lights on and off.

20. The apparatus as recited in claim 15, further comprising a fan towel comprising an extended boarder being configured to fit within said second cavity and a curved hem on a lower edge.
